(19) United States
(12) Patent Application Publication
(10) Pub. No.: US 2005/0129240 A1
(43) Pub. Date: Jun. 16, 2005

(54) Method and apparatus for establishing a secure ad hoc command structure

(75) Inventors: Dirk Balfanz, Menlo Park, CA (US); Diana K. Smetters, San Francisco, CA (US); Glenn E. Durfee, San Francisco, CA (US); Rebecca E. Grinter, San Francisco, CA (US); Paul J. Stewart, Los Altos, CA (US)

Correspondence Address: PATENT DOCUMENTATION CENTER, XEROX CORPORATION, 100 CLINTON AVENUE SOUTH, XEROX SQ. 20 TH FLOOR, ROCHESTER, NY, 14644, US

(73) Assignee: Palo Alto Research Center Incorporated, Palo Alto, CA (US)

(21) Appl. No.: 10/736,323

(22) Filed: Dec. 15, 2003

(51) Int. Cl. H04K 1/00

(52) U.S. Cl. 380/270

(57) ABSTRACT

We present technology that allows layman computer users to simply create, provision, and maintain secured infrastructure—an instant PKI. This technology can be used to quickly establish a secure credential infrastructure that can be used to secure ad-hoc and/or dynamic command and control operations such are needed for Incident Command Systems or other emergency response systems that require simplicity and rapid deployment among disparate responder teams.

### RELATED APPLICATIONS

This application is related to:
U.S. Provisional Patent Application 60/480,909 filed Jun. 24, 2003, entitled “Method And Apparatus For Establishing And Using A Secure Credential Infrastructure” with inventors Smetters, Balfanz, Durfee, Grinter, Stewart, and Wong, hereby incorporated by reference in its entirety herein.
U.S. patent application Ser. No. 10/066,699 entitled “Systems And Methods For Authenticating Communications In A Network Medium” filed Feb. 6, 2002 with inventors Balfanz, Lopes, Smetters, Stewart, and Wong.

### BACKGROUND

1. Field

Embodiments of this invention relate to the field of cryptography.

2. Background

Adoption of public key cryptography has been tremendously limited by the “key management problem” that is, the problem of allowing users to reliably identify the public keys of their intended communication partners. One approach used to address this problem is to construct a Public Key Infrastructure (PKI). This approach designates one or more trusted public keys known by the members of the PKI. The computer system that has the trusted public keys can sign digital certificates containing the public keys of users and devices in the PKI. This process authenticates the public keys of the PKI members.

The primary difficulty addressed by PKI is the problem of key management and distribution. That is, of deciding how to get authenticated copies of particular individuals' or devices' public keys to those individuals and devices that need to rely on these keys. A PKI is a system of well-known trusted public keys, possibly hierarchically organized. In PKI the owner of a trusted key is usually termed a “Certification Authority”, or CA. Those trusted keys are used to authenticate the keys of other members (users and devices) in the PKI by signing the keys for the members, thus creating a “digital certificate”. Such a certificate typically uses this trusted signature to link a public key to information indicating who owns the key (an identity certificate), or what the key is allowed to be used for (an attribute certificate), or at very minimum, just that the bearer of the corresponding private key is a valid member of this particular PKI or other trust system.

Such a PKI simplifies the key management problem, as the number of keys that must be exchanged a priori goes from many down to the number of the trusted public keys. As long as the information contained in a member's certificate is sufficient to indicate to the verifier of that certificate that they are communicating with their intended party, the signature on that certificate is enough to let them know that the public key contained therein belongs to a trusted entity.

Unfortunately, creation and management of PKIs, as well as distribution of certificates, has turned out to be incredibly difficult and complex. Even establishment of small special-purpose PKIs to support the use of public key cryptography for one application within one organization is generally considered to be too expensive and difficult. One reason for this is that the available software is complicated, expensive, and requires deep knowledge of standards and cryptography to be configured to be effective. As a result, in spite of the fact that the use of public key cryptography can dramatically increase the security of many communications protocols (as compared, for example, to password-based alternatives), protocol designers are forced to move to less secure alternatives that do not require the “burden” of PKI establishment. Similarly, this cost of setting up a PKI keeps individuals from considering larger-scale use of public key cryptography in embedded devices (e.g. cell phones, printers, etc), as each of these devices would have to be “provisioned” with a certificate before use.

Furthermore, the key management and distribution problem described above in the PKI context exists with any secure credential infrastructure that has a credential issuing authority to issue credentials.

In the area of emergency response it is difficult to implement a secure credential infrastructure in the short timeframe required by the immediate nature of an emergency, thus, radio communications between responder teams or individual responders are public. This limits the information that can be clearly communicated because there are privacy constraints on the dissemination of this information.

Further, it is difficult to keep track of a dynamic ad hoc command structure as the command structure can change form as an incident that invoked the command structure evolves.

It would be advantageous to be able to quickly setup and use a secure credential infrastructure such as a PKI to provide secure emergency communication between responder team and individual responders such that each responder could be informed of the current command structure, their responsibilities, position, and situation and such that the commanders would have automated,mechanisms for changing command structure, changing responsibility and duty assignments, and etc.

### DESCRIPTION OF THE DRAWINGS

FIG. 1 illustrates a networked computer system in accordance with one embodiment;

FIG. 2 illustrates a secure credential infrastructure construction process in accordance with one embodiment;

FIG. 3 illustrates a credential issuing authority configuration process in accordance with one embodiment;

FIG. 4 illustrates a process that can be used by a credential issuing device to pre-authenticate a prospective member device over a preferred channel in accordance with one embodiment;

FIG. 5 illustrates a process that can be used by a prospective member device to pre-authenticate a credential issuing device over a preferred channel in accordance with one embodiment;

FIG. 6 illustrates an automatic prospective member device credential provisioning process in accordance with one embodiment;

FIG. 7 illustrates one embodiment of the prospective member device provisioning process;

FIG. 8 illustrates steps for using a computerized personal incident assistant in accordance with one embodiment; and

FIG. 9 illustrates a personal incident assistant in accordance with one embodiment.

### DESCRIPTION OF THE PREFERRED EMBODIMENTS

One aspect of the embodiments disclosed herein is technology for creating a simple-to-use secure credential infrastructure. Such an infrastructure could be, for example, an “Instant PKI”. That is, a PKI that is simple to establish, configure and use without diminishing the security provided by the PKI.

Another aspect is technology for enabling a computerized personal incident assistant to securely communicate through a secure credential infrastructure in support of an ad hoc command structure such as one established in accordance with an Incident Command System (ICS).

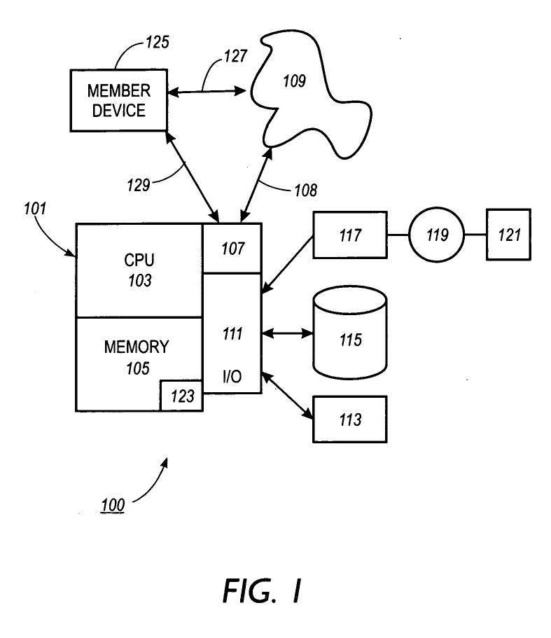

FIG. 1 illustrates a networked computer system 100 that incorporates one embodiment of the invention. The networked computer system 100 includes a computer 101 that incorporates a CPU 103, a memory 105, and a network interface 107. The network interface 107 provides the computer 101 with access to a network 109 over a network connection 108. The computer 101 also includes an I/O interface 111 that can be connected to a user interface device(s) 113, a storage system 115, and a removable-media data device 117. The removable-media data device 117 can read a computer readable media 119 that typically contains a program product 121. The storage system 115 (along with the removable-media data device 117) and the computer readable media 119 comprise a file storage mechanism. The program product 121 on the computer readable media 119 is generally read into the memory 105 as a program 123. In addition, the program product 121, or updates to same, can be provided from the network as computer instruction signals embodied in a transmission medium (with or without a carrier wave upon which the signals are modulated or other data transporting technology—including light, radio, and electronic signaling) through the network interface 107. One skilled in the art will understand that a device in communication with the computer 101 can also be connected to the network 109 through the network interface 107 using the computer 101.

A member device 125 can also communicate over the network 109 over a network connection 127. The member device 125 can also communicate with the computer 101 over a preferred channel 129 through the network interface 107 or the I/O interface 111 (not shown).

One skilled in the art will understand that not all of the displayed features of the networked computer system 100 nor the computer 101 need to be present for all embodiments of the invention. Further, such a one will understand that the networked computer system 100 can be a networked appliance or device and need not include a general-purpose computer. The network connection 127, the network connection 108, and the preferred channel 129 can include both wired and wireless communication. In addition, such a one will understand that the user interface device(s) 113 can be virtual devices that instead of interfacing to the I/O interface 111, interface across the network interface 107.

Further, one skilled in the art will understand that a procedure can be a self-consistent sequence of computerized steps that lead to a desired result. These steps can be defined by one or more computer instructions. These steps can be performed by a computer executing the instructions that define the steps. Thus, the term “procedure” can refer (for example, but without limitation) to a sequence of instructions, a sequence of instructions organized within a programmed-procedure or programmed-function, or a sequence of instructions organized within programmed-processes executing in one or more computers. Such a procedure can also be implemented directly in circuitry that performs the steps. Further, computer-controlled methods can be performed by a computer executing an appropriate program(s), by special purpose hardware designed to perform the steps of the method, or any combination thereof.

One embodiment is directed to the construction of a secure credential infrastructure. Such secure credential infrastructures include wired and wireless networks that use keys (for example, secret keys, or public-private key pairs) to encrypt information sent over a network such that the data representing the encrypted information only carries meaning to those computers that have the correct key, or a credential infrastructure that allows devices to use credentials to authenticate to other members, or to use credentials to authenticate to other members or service providers (for example, logging onto a Windows domain using a smart card that has a credential stored within it). This embodiment applies to secure credential infrastructures such as a public key infrastructure, to wireless networks (for example those using WEP encryption, or other wireless encryption standard), to wired networks, and to hybrid networks. One embodiment of the invention can be used to add target devices to a public key infrastructure (PKI) and thus, construct a PKI having member devices. Although much of the following is directed towards a secure credential infrastructure, one skilled in the art will understand that the inventive aspects apply as well to a PKI.

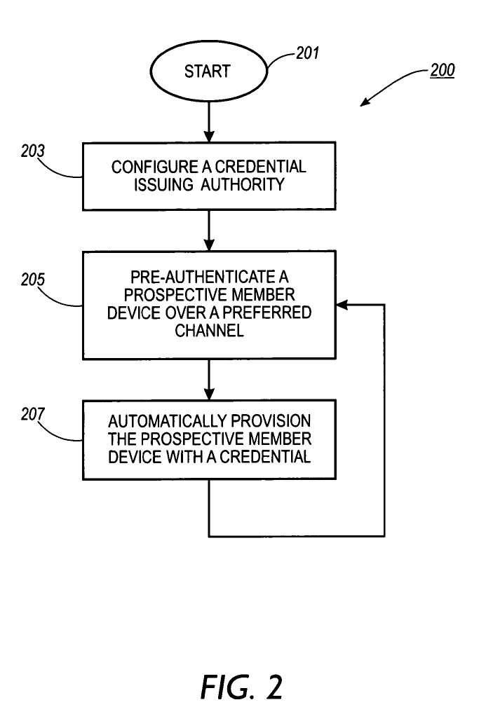

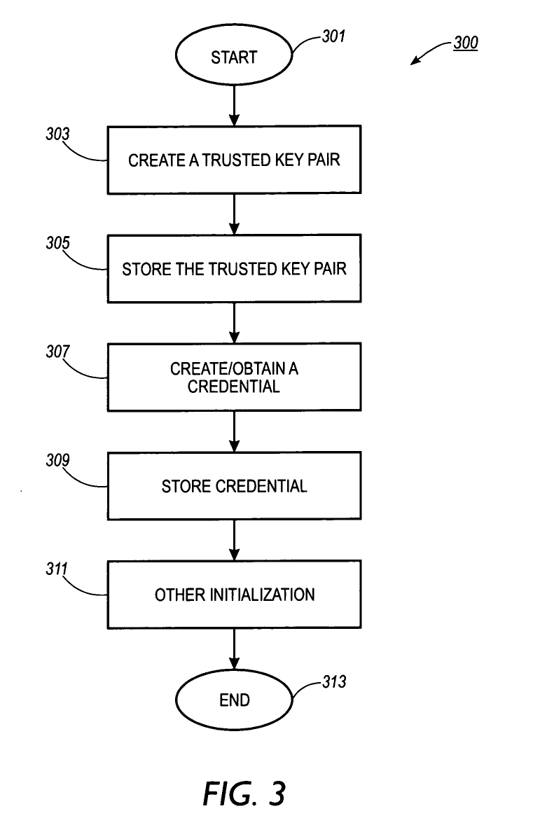

FIG. 2 illustrates a ‘secure credential infrastructure construction’ process 200 that is invoked when power is first applied to a credential issuing device, or when the credential issuing device is reset. The ‘secure credential infrastructure construction’ process 200 initiates at a ‘start’ terminal 201 and continues to a ‘credential issuing authority configuration’ procedure 203 that configures a credential issuing authority (for example a certification authority for a PKI) as is subsequently described with respect to FIG. 3.

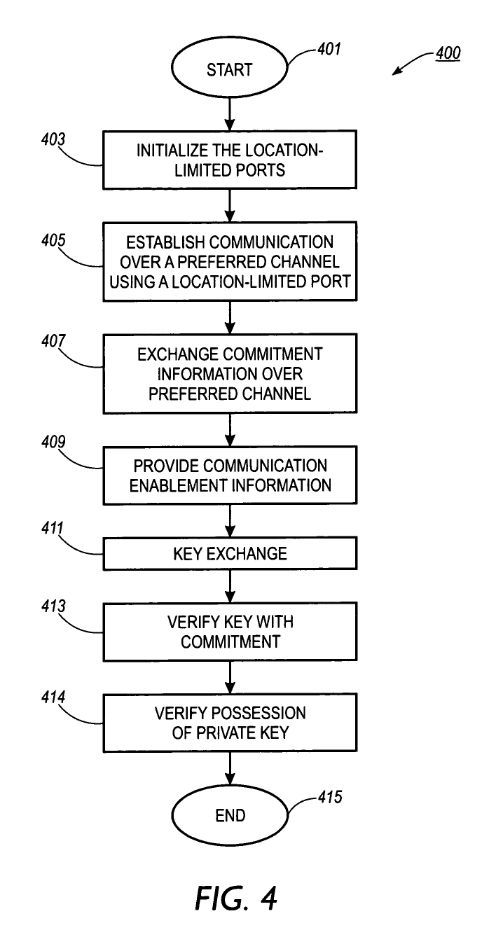

Once the certification authority is configured, the ‘secure credential infrastructure construction’ process 200 continues to a ‘prospective member device pre-authentication’ procedure 205 that detects when a prospective member device is available to communicate to the credential issuing device over a preferred channel, optionally provides network configuration information to the prospective member device to enable it to communicate with the credential issuing device over some network other than the preferred channel, and pre-authenticates the prospective member device. The ‘prospective member device pre-authentication’ procedure 205 is subsequently described with respect to FIG. 4.

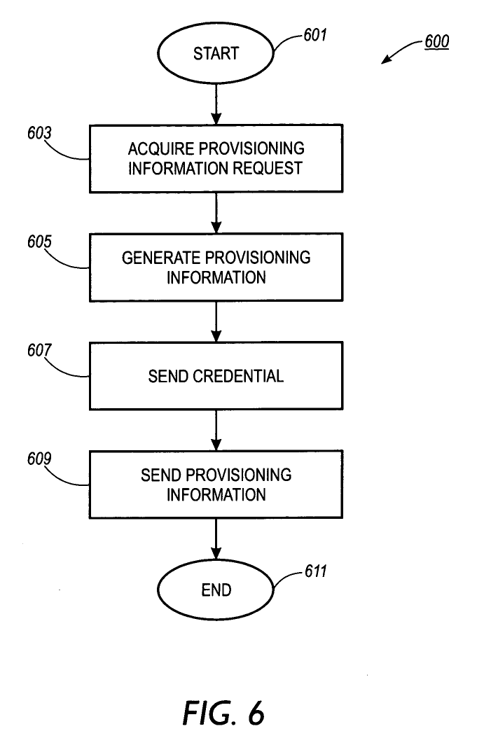

Once the prospective member device is pre-authenticated, an ‘automatically provision prospective member device with credential’ procedure 207 provisions the prospective member device by providing the prospective member device with a credential (in the PKI case, a public key certificate) for the prospective member device as well as the credential issuing device's public key certificate and any other information that is requested by the prospective member device, or automatically provided by the or enrollment station. Once provisioned, the prospective member device becomes a member device of the secure credential infrastructure. The ‘automatically provision prospective member device with credential’ procedure 207 is subsequently described with respect to FIG. 6.

The ‘secure credential infrastructure construction’ process 200 repeats back to the ‘prospective member device pre-authentication’ procedure 205 for each prospective member device to be added to the secure credential infrastructure.

A credential can include a X.509 certificate, a WTLS certificate, a SPKI certificate, an attribute certificate, or any other association of a key or secret with trust, access, or identity.

Once the prospective member device is provisioned it becomes a member device and can use its credential as is known in the art. This includes using the credential to enable secure communications across a network, to use credential to provide access to devices, networks, services, containers, office space, or other device, area, or service that requires authentication and/or authorization or a credential to access.

Any device that performs the ‘secure credential infrastructure construction’ process 200 as well as any device that performs provisioning services for other secure networks is contemplated as a credential issuing device. Often, the credential issuing device includes a credential issuing authority (in the context of a PKI, a certification authority (CA)). One skilled in the art will understand that a public key infrastructure is but one instance of a secure credential infrastructure that includes a credential issuing authority (such as a certification authority) that provides a credential (such as a public key certificate) through a credential issuing device to the prospective member device. Possession of the credential by the prospective member device makes the device a member device of the secure credential infrastructure. Possession of the credential provides the member device with the ability to authenticate and/or authorize, or to access.

The preferred channel can be a location-limited channel or any other channel that has both a demonstrative identification property and an authenticity property.

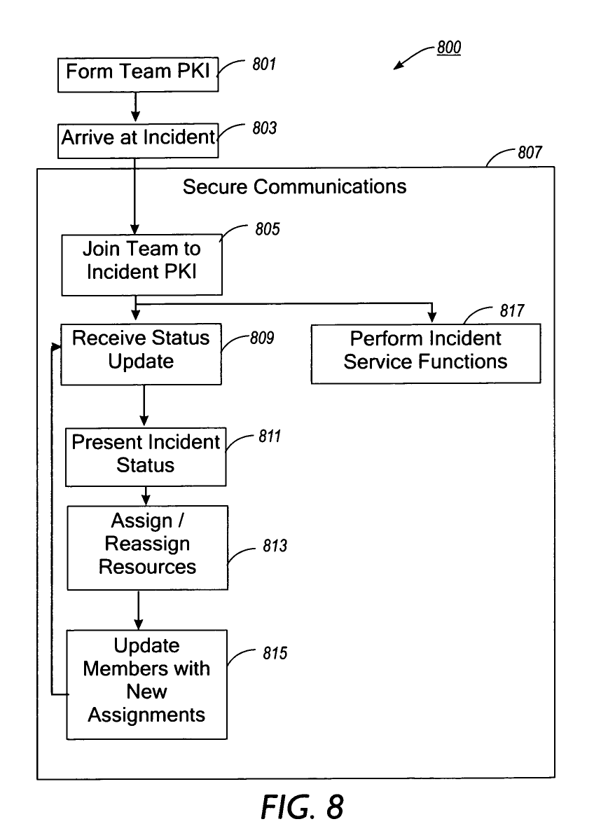

The demonstrative identification property requires that identification be based on a physical context (for example but without limitation, “the printer in front of me,” “all PDA's in the room,” or “this device that I am touching”). The preferred channel uses communication technologies that have inherent physical limitations on their transmissions. Examples (but without limitation) of such technologies include visible or invisible electromagnetic radiation communication such as infrared communications, communications through a short run of wires, audio (both audible, and inaudible (for example ultrasonic)), communication by passing information from one device to another device using a physical computer-readable media (such as a removable media or drive (for example, a floppy disk, a removable disk, a USB storage device (such as a flash memory pen or disk drive) or other tangible data carrier)), physical electrical contact, near-field signaling across the body, and short range RF, as well as embodiments that require an operator to enter a code (other examples can be found in the discussion with respect to FIG. 8). The demonstrative identification property of the preferred channel means that human operators are aware of which devices are communicating with each other over the preferred channel and that the human operators can easily detect when an attack is being made on the preferred channel.

The authenticity property of the preferred channel means that it is impossible or difficult for an attacker to transmit over the preferred channel or tamper with messages sent over the preferred channel without detection by the legitimate parties to the communication.

The preferred channel does not require secrecy (that is, an attacker can monitor the transmissions on the preferred channel) so long as the attacker cannot transmit on the preferred channel without detection. Because of the location-limited nature of the preferred channel, it is difficult for an attacker to monitor the channel, let alone transmit on the channel without detection. Further, detection only requires that the human participants know the number of the participants (devices) who are communicating over the preferred channel.

As is subsequently described, the use of the preferred channel to pre-authenticate the participants' keys allows the administrator of the secure credential infrastructure to be assured that the keys are only provided to prospective member devices that have access to the preferred channel. Thus, establishing “trust” because the user of the prospective member device must have had physical access to the preferred channel (for example, when the user is an employee and has had access to the building where the preferred channel is located).

During the pre-authentication process, commitments (commitments are subsequently described) to each participant's public keys are exchanged over the preferred channel. Once the commitments are exchanged, the devices can perform a key exchange protocol or procedure and establish further secure communication using any method known in the art. To illustrate, once a key is received, it is verified by checking that the received key matches the commitment that was provided via the preferred channel. Once the keys are verified, well-known techniques can be used to commence communication using the keys (and in addition, in the case of a public key, also verifying that the other device holds the private key corresponding to the provided public key). Once the public keys are verified and the provider of the public key proves possession of the private key that corresponds to the public key, the credential issuing authority can provide a credential to the prospective member device for its use such that the prospective member device becomes an actual member device of the PKI.

A commitment to a piece of information X is a piece of information C that can be verified to match X. A commitment is “binding,” when it is cryptographically difficult for an attacker, even knowing X and C, to produce a different piece of information Y that C will also match.

A commitment is “hiding” when it cryptographically difficult for an attacker knowing C to extract even partial information about X.

An example of a binding and hiding commitment to X can be H(X) where H can be a cryptographically secure hash function. One skilled in the art will understand from the context whether the commitment used needs to be binding, hiding, or both.

A commitment can be used to establish trust if it is received over a preferred channel or endowed with a digital signature from a party the recipient trusts. A trusted commitment allows the level of trust of a matching piece of information (possibly received over an untrusted channel, or unsigned) to be elevated to the same level of trust as the commitment.

FIG. 3 illustrates a ‘credential issuing authority configuration’ process 300 that can be used by the ‘credential issuing authority configuration’ procedure 203 of FIG. 2. This process can be used to initialize the credential issuing device so that it has a trusted credential. The ‘credential issuing authority configuration’ process 300 initiates at a ‘start’ terminal 301 and continues to a ‘create trusted key pair’ procedure 303 that generates public and private keys using well-known techniques. Once the trusted key pair is generated, a ‘store trusted key pair’ procedure 305 stores the trusted key pair on a storage device (for example, but without limitation, a disk, a cryptographic token, network device, network storage, memory card, etc.). Once the trusted key pair is generated, the ‘credential issuing authority configuration’ process 300 continues to a ‘create issuing authority credential’ procedure 307. One skilled in the art will understand that there are other types of credential systems other than certification systems that can be provisioned as described herein.

The ‘create issuing authority credential’ procedure 307 can create a self-signed credential (a “root” credential). The ‘create issuing authority credential’ procedure 307 can also access a parent certification authority to obtain a chained credential and to import the chained credential back to the credential issuing device. Once the credential is created or obtained, a ‘store issuing authority credential’ procedure 309 stores the credential in some available storage for subsequent use.

Other services or features can be initialized by an ‘other initialization’ procedure 311. These services and/or features can include directory services, generation of certificate revocation lists (CRLs) or credential status processing as well as other services. In addition, these services can include, for example, key-pair generation services, 802.11a/b/g provisioning services, network address provisioning services etc. The ‘credential issuing authority configuration’ process 300 completes through an ‘end’ terminal 313.

FIG. 4 illustrates a pre-authentication process for a credential issuing device 400 that can be used by the ‘prospective member device pre-authentication’ procedure 205 of FIG. 2.

The pre-authentication process for a credential issuing device 400 can be used to establish trust between the credential issuing device and the prospective member device such that the prospective member device can be provisioned with a credential and become a member device of the secure credential infrastructure.

The pre-authentication process for a credential issuing device 400 initiates at a ‘start’ terminal 401 and continues to an ‘initialize location-limited ports’ procedure 403 that activates one or more I/O ports of the credential issuing device that will be used to establish a preferred channel with the prospective member device.

A preferred channel can be established using any location-limited communication mechanism such as those described with respect to FIG. 8. Once the preferred channel ports are initialized, the pre-authentication process for a credential issuing device 400 continues to an ‘establish communication over preferred channel’ procedure 405 that establishes communication over the preferred channel between the credential issuing device and the prospective member device using one of the location limited ports initialized by the ‘initialize location-limited ports’ procedure 403. Once communication is established between the prospective member device and the credential issuing device (for example by aligning IR ports on the devices), the pre-authentication process for a credential issuing device 400 continues to an ‘exchange commitment information’ procedure 407 that generates a commitment for the public key. The commitment will be sent to the prospective member device over the preferred channel. The commitment can be a portion of the public key, the public key itself, an encoding of the public key, a mathematical function of the public key or other function of the key generated by any commitment technique. The credential issuing device also receives a commitment from the prospective member device for the key or secret that the prospective member device will send to the credential issuing device.

Next a ‘provide communication enablement information’ procedure 409 can provide the prospective member device with network configuration information required for the credential issuing device to communicate to the prospective member device over the desired communication media (as compared to the preferred channel). For example, where the credential issuing device is a WAP, it could specify the SSID and possibly a wireless channel selection and/or a WEP key; for a wired network, the credential issuing device could specify a specific MAC address and/or static IP address. One skilled in the art will understand that the ‘provide communication enablement information’ procedure 409 is optional in many embodiments and that the prospective member device can be pre-configured for network communication. However, one advantage of the ‘provide communication enablement information’ procedure 409 is that it simplifies the network configuration process for the prospective member device. For example, but without limitation, the credential issuing device can automatically assign a fixed network address to the prospective member device (as compared to a DHCP address), specify a SSID, specify a WEP key, a domain name, an IP address, a VPN address, gateway address, Bluetooth address, security settings, security policies, bit lengths, or other information needed to establish communication between the credential issuing device and the prospective member device over a channel other than the preferred channel. In addition, other information can be provided beyond just network configuration information. Furthermore, the communication enablement information can be used to bootstrap a secure communication channel that can be used to further provision the prospective member device, for example as is subsequently described with respect to FIG. 6. In addition, similar information can be provided during subsequent provisioning using a secure channel.

Once the commitments are exchanged, an ‘key exchange’ procedure 411 exchanges keys (for example using any key-exchange protocol known in the art) such that the credential issuing device and the prospective member device will be able to perform communication over a network that is not the preferred channel. The ‘key exchange’ procedure 411 need not use the preferred channel or an encrypted data path to exchange public keys. However, if secret keys are being exchanged secure communication are required (such as using the committed-to keys to establish secure communication over a non-preferred network; and using the established secure communication channel to negotiate exchange of a secret key). Furthermore, the preferred channel can be used with the ‘key exchange’ procedure 411 so long as any secret data is encrypted (and preferably using a protocol such as SSL). This can be useful where the preferred channel has sufficient bandwidth to timely carry the protocol.

Once the keys are exchanged, a ‘verify keys with commitment’ procedure 413 verifies that the received key matches the commitment (this can be done both by the credential issuing device and the prospective member device with the commitments and keys they have received respectively). For example, verifying that a received key matches a commitment can be performed by computing a cryptographic hash of the key and verifying that this hash is equal to the commitment. Once the public keys are verified by the commitment information, a ‘verify possession of private key’ procedure 414 establishes proof that the device providing the verified public key also has possession of the corresponding private key (for example using a key-pair validation mechanism that uses techniques well known in the art). Finally, the pre-authentication process for a credential issuing device 400 completes through an ‘end’ terminal 415.

In one embodiment of the invention, the actual key can be provided as the commitment. Then when keys are exchanged, verifying that the received key matches the previously received commitment can be done simply by verifying that they are equal.

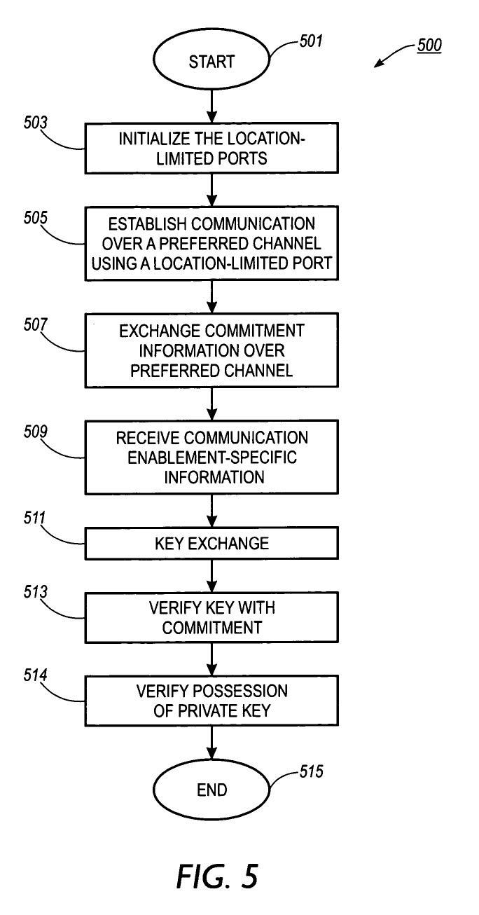

FIG. 5 illustrates a pre-authentication process for a prospective member device 500 that is very similar to the pre-authentication process for a credential issuing device 400 of FIG. 4. The pre-authentication process for a prospective member device 500 includes a ‘start’ terminal 501, an ‘initialize location-limited ports’ procedure 503, an ‘establish communication over a preferred channel’ procedure 505, an ‘exchange commitment information’ procedure 507, a ‘receive communication enablement information’ procedure 509, an ‘key exchange’ procedure 511, a ‘verify keys with commitment’ procedure 513, a ‘verify possession of private key’ procedure 514, and an ‘end’ terminal 515. These procedures are substantially the same as the corresponding procedure shown in FIG. 4 with the exception of the ‘receive communication enablement information’ procedure 509.

The ‘receive communication enablement information’ procedure 509 receives the information provided by the credential issuing device at the ‘provide communication enablement information’ procedure 409 and conditions the prospective member device so that it can communicate over one or more networks, or otherwise processes the communication enablement-specific information as appropriate.

With regards to the ‘establish communication over preferred channel’ procedure 405 and the ‘establish communication over a preferred channel’ procedure 505, there are at least two modes for establishing communication over the preferred channel. These modes differ in how the communication is established. In a first mode, the prospective member device can explicitly initiate the connection to the credential issuing device over the preferred channel and request a credential (either as part of an initial auto-configuration of the client, in request to stimuli from the environment—for example, detection of a new wireless network—, as a result of input from the user, or by an automated discovery process). This can be accomplished by having the prospective member device initiate the exchange of credentials with the designated the credential issuing device. One example of establishing a preferred channel is by aligning infrared or visible light ports of the prospective member device and the credential issuing device. Additional examples of connection examples are subsequently described with respect to FIG. 8.

Designation of the credential issuing device can be explicit (for example, “this device to which I have established an electrical connection”, “this device I touch,” “this device that is aligned with a specific IR port,”) or implicit (for example, “any device that can receive audible signals issued from my device”).

In the second mode, the communication over the preferred channel can be initiated by the credential issuing device in response to an action such as a user placing the prospective member device in a cradle attached to the credential issuing device by a serial port, or USB port or by having the prospective member device respond to a credential-granting token associated with the secure credential infrastructure. Using this approach, the prospective member device generally can be configured to be able to accept the pre-authentication requests from the credential issuing device. The prospective member device in this configuration, for example, can be executing an application that receives credentials and determines and processes the received credentials. In another example, the prospective member device can support a background program (for example, a UNIX daemon) that receives the credential and makes it available to other registered applications (with optional user confirmation or other feedback). Note that the cradle should not be a wireless cradle (that is, a cradle that wirelessly sends information to the credential issuing device) unless the communication between the cradle and the credential issuing device is secure.

A credential-granting token can include portable credential issuing devices (like a JAVA card), smart cards that can create credentials and directly provision prospective member devices. Other devices can, for example, serve as storage devices for accumulating and storing commitments between a group of prospective member devices that are to belong to a secure credential infrastructure. Finally, the credential issuing device can require identification of a key to enable the credential issuing function of the credential issuing device (for example, such a key can be a USB storage or biometric sensor that must be accessed prior to the credential issuing device provisioning a credential).

One skilled in the art will understand that the commitment to the key is transferred over the preferred channel because the preferred channel is assumed to be resistant to undetected active attacks and to thereby endow data transferred across it with the authenticity property. A channel does not need to be resistant to eavesdroppers to be used as a preferred channel because only public information (e.g. a public key, or a commitment to a public key) is sent over that channel; a pair of devices authenticating themselves to each other by sending such key or commitment information over the preferred channel are able to set up a secure communication with each other because they can demonstrate possession of the private keys corresponding to the public keys committed to or exchanged over the preferred channel (using any technique known in the art, such as a key exchange protocol like SSL/TLS). An eavesdropper that detects the commitment or keys sent across the preferred channel is not able to demonstrate possession of the corresponding private key, and therefore is unable to affect communication between the legitimate parties. Further, one skilled in the art will understand that the preferred channel can be a very low bandwidth channel as only needs to carry the key commitment (and possibly essential communication parameters for the non-preferred channel—such as a LAN, or Internet). The provisioning of the credential and other information to the prospective member device can be accomplished using the non-preferred channel(s).

Example protocols for exchanging commitments follow:

Pre-authentication for two keys, taking place over the preferred channel:
1. A→B: addr_{A}, h(PK_{A})
2. B→A: addr_{B}, h(PK_{B})
   Authentication continues over a non-preferred (wireless) channel with any standard key exchange protocol to exchange PK_{A} and PK_{B} to establish secure communications, e.g.:
1. A→B: TLS CLIENT HELLO
2. . . . and so on.
   The various symbols denote:
addr_{A}, addr_{B}: A's (resp. B's) address in wireless space, provided strictly for convenience;
PK_{A}, PK_{B}: the public key belonging to A (resp. B), either a long-lived key or an ephemeral key used only in this exchange;
h(PK_{A}): a commitment to PK_{A,} e.g., a one-way hash of an encoding of the key.

Pre-authentication for one key, taking place over the preferred channel:
1. A→B: addr_{A}, h(PK_{A})
2. B→A: addr_{B}, h(S_{B})
   Authentication continues over a non-preferred (wireless) channel with any standard key exchange protocol to exchange PK_{A} and a secret, e.g.:
1. A→B: PK_{A}
2. B→A: E_{PKA}(S_{B})
   The various symbols denote:
addr_{A}, addr_{B}: A's (resp. B's) address in wireless space, provided strictly for convenience;
PK_{A}: the public key belonging to A either a long-lived key or an ephemeral key used only in this exchange;
S_{B}: a secret belonging to B;
h(PK_{A}): a commitment to PK_{A}, e.g., a one-way hash of an encoding of the key;
h(S_{B}): a commitment to S_{B}
E_{PKA}(S_{B}): the encryption of S_{B} Under PK_{A}

FIG. 6 illustrates an automatic prospective member device credential provisioning process 600 that can be used by the ‘automatically provision prospective member device with credential’ procedure 207 of FIG. 2. The automatic prospective member device credential provisioning process 600 provisions the prospective member device with the credential. It also sends the prospective member device other provisioning information (for example, information requested by the prospective member device or that is automatically provided by the credential issuing device.

The automatic prospective member device credential provisioning process 600 initiates at a ‘start’ terminal 601 and continues to an ‘acquire provisioning information request’ procedure 603. The ‘acquire provisioning information request’ procedure 603 can receive a request for provisioning information from the prospective member device. In addition, the ‘acquire provisioning information request’ procedure 603 can detect a condition that triggers the credential issuing device to provide pre-determined or user selected provisioning information. The request can include requests for information or services beyond that of just providing a credential.

Once the credential issuing device acquires the request, a ‘generate provisioning information’ procedure 605 generates a credential (such as one or more public key certificates) and any other requested provisioning information. The ‘generate provisioning information’ procedure 605 can include requesting authorization for the credential from a registration agent (for example from an RA in a PKI).

A ‘send credential’ procedure 607 causes the credential issuing device to send one or more credentials to the prospective member device. Once the prospective member device receives the credential, it becomes a member device of the secure credential infrastructure. Also, a ‘send provisioning information’ procedure 609 sends the provisioning information from the credential issuing device to the prospective member device.

The prospective member device can also request that it be provisioned with a key-pair generated by a credential issuing device or any other information that may be available. One skilled in the art will understand that some embodiments can send provisioning information that is not requested by the prospective member device (for example, application specific information).

Furthermore, the prospective member device can be provisioned with information that can be used by the prospective member device to establish a Virtual Private Network (VPN) with some other member device, security gateway, etc.

One skilled in the art will understand that the ‘automatically provision prospective member device with credential’ procedure 207 in some embodiments will only provision the prospective member device with the credential, while other embodiments will provision the prospective member device with both the credential and other requested (or default) provisioning information (and in some embodiments may not provision a credential at all—see FIG. 10 and its discussion).

The provisioning information can be any information that can be used by the prospective member device. This information can include application specific information, site specific information, network specific information, or other information. This information can also include, for example but without limitation, information such as application-dependent information, device-specific assignment information (for example, in a hospital environment, the name of the patient, the case number, or other data-acquisition information required to capture data from the device or to cause the device to operate), database access information, cell phone provisioning information (such as the cell phone number), any kind of owner information, vehicle information, location information, information required to establish a secure communication link (for example VPN-related information), collaborative work space information, radio channel, any kind of application specific information, and information required to access a database. Thus, the term “provisioning” applies to the providing of a credential, as well as the providing of other information that can be used by a member device. In some embodiments, the provisioning information can be provided using multiple communication channels. In particular, the preferred channel can be used to send provisioning information to bootstrap subsequent communication (secure or not secured) over the preferred or non-preferred channel (for example, information necessary to establish temporary communication over a non-preferred channel). The two parties can then go on to exchange additional provisioning information over that non-preferred channel subsequent to the ‘key exchange procedure’ and ‘key verification procedure’ described above, which can be used to establish secure and authenticated communication between the parties over that non-preferred channel. This additional provisioning information can contain any of the provisioning information types described above, including communication enablement information sufficient to allow the new member device to communicate on another non-preferred network connection not used during the provisioning. In other embodiments, the preferred channel can be exclusively used to provision the prospective member device, possibly with the use of a key exchange protocol to additionally secure some of that communication. The more common embodiment will be where a first set of provisioning information is provided over the preferred channel, and other provisioning information is provided using a second (generally secure) communication channel.

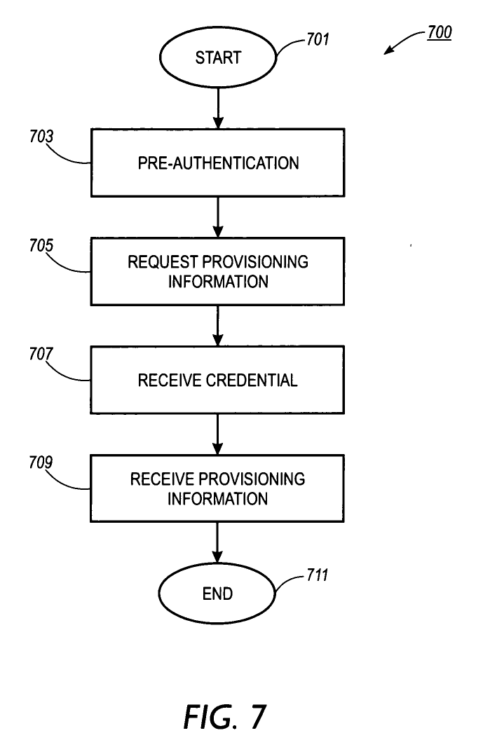

FIG. 7 illustrates a ‘prospective member device-side provisioning’ process 700 that can be used by the prospective member device to automatically receive a credential and other provisioning information from the credential issuing device. The ‘prospective member device-side provisioning’ process 700 initiates at a ‘start’ terminal 701 generally responsive to an event (for example, the detection of the potential for establishing a preferred channel, or in response to a user's action), and continues to a ‘pre-authentication’ procedure 703 (that invokes the pre-authentication process for a prospective member device 500 that has been previously described with respect to FIG. 5). Once the ‘pre-authentication’ procedure 703 completes, the prospective member device can communicate over a network. At a ‘request provisioning information’ procedure 705, the prospective member device sends a request for a credential and any other desired and available provisioning information. A ‘receive credential’ procedure 707 receives the credential and at a ‘receive provisioning information’ procedure 709 receives other requested provisioning information that was sent by the automatic prospective member device credential provisioning process 600. The received credential and possible other provisioning information can then be made available for use (whether by applications within the prospective member device, by readers of the prospective member device, or by other ways known in the art to use the credential). The ‘prospective member device-side provisioning’ process 700 completes through an ‘end’ terminal 711.

A number of situations exist where command and control infrastructure must be established in a dynamic and/or ad hoc manner. These situations include dynamic military situations and emergency response situations. In both cases, secure information needs to be passed between a group of individuals who are working together to perform a mission or to respond to an incident. In these situations, the environment; and the organization, responsibility, and duties of the individuals involved in the mission or responding to the incident can be very dynamic.

One emergency response framework is the Incident Command System (ICS). ICS provides an organization for managing the response to an incident by disparate responder teams (each having their own chain-of-command), regardless of whether the incident is small, large, or changing. One aspect of incident management is that new responder teams and individual responders who arrive to assist with the incident must rapidly be incorporated into the ICS (or equivalent) framework.

One problem with ICS and similar systems is a result of the flexibility of the incident management structure. ICS allows independent responder teams to participate in the handling of the incident without a common chain-of-command (for example, fire departments, police departments, and national guard units do not have a common chain-of-command). Still, the efforts of the responder teams must be coordinated and this coordination is accomplished under the control of an Incident Commander who has authority across the responder organizations. Thus, as the incident grows, and as new responders arrive to help with the incident, the assignments, functions and duties of the current responders change under the control of the Incident Commander (or his/her delegate). Thus, while the command-and-control of an individual responder or a responder team stays the same (and operates vertically within that responder's organization), the incident control responsibility of the Incident Commander spans across responder organizations. The problem with this approach is that it is very difficult to keep each of the responder teams aware of the reporting and communication channels that should be used at any particular point in time because these channels change as responders arrive, rest, are relieved, and as the responder's assignments, duties, and responsibilities change during the life of the incident.

Another difficulty with ICS implementations is the difficulty and time-lag related to knowing where responder teams are located. Currently, each individual responder must verbally report their position up the chain-of-command which is then reported to the Incident Commander.

Often small ICS implementations (for example, fire departments) use a drawing on a whiteboard or similar structure at the Incident Control center to monitor the on-site responder teams, their location, reporting structure, responsibilities, tasks, and other information. Even large ICS systems often have a similar manual method for capturing the status of the responder teams. The communication of this information does not rapidly flow to the responder teams from the Incident Control center because as changes occur, they must be manually communicated to the responder teams. In addition, because incident related communications is on an open radio channel (using know frequencies and known terminology), some types of information cannot be explicitly discussed because of privacy related issues and/or security related issues. Thus, some information must be passed by personal contact.

One reason for this cumbersome manual organizational mechanism is that it takes too long to configure current secure wireless communication between two or more computers during an incident. In addition, because the timing and severity of the incident can not be predicted, and because the available responder teams are unknown at the time of the incident, traditional secure credential infrastructure can not be effectively established prior to the incident.

Unlike other organizations, emergency response agencies must fulfill their responsibilities under conditions that are hazardous and often confusing. While other organizations can take time to form a committee to study a problem, decisions at the emergency scene must be made based on limited information and under severe time restrictions. Just because an emergency exists does not relieve those responsible for managing the emergency from doing so in a professional manner. Because of the risks and dangers involved, the need for effective incident management is greater than in other organizations.

Thus, using secure communications has not been a reasonable alternative in the past due to the overhead and difficulty of setting up a PKI or other secure credential infrastructure.

Having the ability to easily construct a secure credential infrastructure, as has been previously described, provides the opportunity to simply and quickly establish secure data and voice communications for use in the ICS framework (or other ad hoc command-and-control system) to provide secure digital information between all or some members of the infrastructure. For example, an incident commander (such as a fire chief) can add a law enforcement officer or group of officers simply by using a location limited channel to create a secure credential infrastructure (such as a PKI) for the law enforcement officers. In addition the incident commander can assign responsibilities, delegate tasks, recognize emergencies, and monitor the location of the individuals associated with the member devices of the secure credential infrastructure.

One skilled in the art will understand from the previous description that a PKI is but one example of a secure credential infrastructure. Although applicant describes the following embodiment using PKI terms, the embodiment can also be implemented with any quickly configured secure credential infrastructure.

FIG. 8 illustrates a process for the use of a computerized personal incident assistant 800 that includes a ‘form responder team PKI’ step 801. Each individual of the responder team has a computerized personal incident assistant that provides each responder with the ability to receive secure communications as well as providing the responder with a number of incident management tools. Secure communications (of data and/or voice) is available by establishing a secure credential infrastructure between the individuals of the responder team.

The ‘form responder team PKI’ step 801 is generally accomplished by the responder team when the individual comes on duty (generally prior to the incident). An alternative is to perform the ‘form responder team PKI’ step 801 while the responder team is in transit from their base to the incident site. The responder team forms the PKI by using a preferred channel (for example a location-limited channel) to establish trust between the team members and establishing the PKI as has been previously described.

Once the ‘form responder team PKI’ step 801 is complete, each member of the team has a public key certificate or a public key certificate chain that allows electronic communication between the members of the responder team as each individual's computerized personal incident assistant is a member device of the PKI.

An ‘arrive at incident’ step 803 happens when the responder team arrives at the incident site. Once the responder team arrives they join the incident PKI at a ‘join team to incident PKI’ step 805. The inventors contemplate at least two types of joining interactions with the established incident site PKI (if the responder team is the first responder on site, their PKI will become the incident site PKI and the initial responder team will establish a command-system).

The first type of joining interaction is that the responder team locates the incident commander or his/her designate and uses a preferred channel capability of the responder team's member device that established the responder team's PKI to exchange Cross-Certificates (for example, by performing a peer-to-peer cross-certification) and thus merge the responder team's PKI with the incident site PKI. This can be accomplished by use of an enrollment station that would generally be part of, or co-located with a check-in station. The enrollment station could also be associated with a situation assessment station.

The second type of joining interaction is that the responder team locate any person who has a member device of the incident site PKI and by establishing trust with that person (through a preferred channel) to either exchange Cross Certificates, or to add the responder team directly to the incident site PKI.

In both types, by following the previously described technology, a public key certificate is established by exchanging key commitment information over a preferred channel between a credential issuing device and the prospective member device to pre-authenticate the prospective member device. Once the prospective member device is pre-authenticated, the credential issuing device receives a public key from the prospective member device and verifies the public key with the key commitment information. Finally, the credential issuing device automatically provisions the prospective member device with public key certificate at which time the prospective member device becomes a member device associated with the PKI (or other secure credential infrastructure).

Another type of joining interaction is where two, initially separate, incidences become one (such as when two forest fires merge). This is handled by performing a cross-certification of each of the incident PKIs where the root CAs sign each other.

Another type of joining interaction would be to use pre-authorization to obtain public key certificate information about a just-arrived responder team and cross-certify it or maintain a list of public key certificates that can operate within the secure credential infrastructure. In another type of joining interaction, the person in charge of the responder team can interact with the check-in station to request a public key certificate for each of the responder team members to be distributed over the network.

Once the responder team's computerized personal incident assistants are members of the incident site PKI, future communications using the incident site PKI are secure (as is shown by a secure communication enabled block 807). There are at least two methods that can be used by the command-system to provide command-system information to the responder team and/or individual responders using the incident site PKI.

The first method assumes that all secure communication between the member device of the PKI can be accessible to each member device (thus, once a prospective member device becomes a member device, there are no further security restrictions applied to that device with respect to the PKI, and that any member device selection is accomplished by data structures or commands that are addressed to the particular member device (even if the communication of the data structure or command is secure).

Another method is to provide a unique public key certificate chain including appropriate policy constraints for each member device such that one member device would only have access to communications enabled by the policy constraint.

Regardless of which method is used to secure communications between the member devices, a ‘receive status update’ step 809 receives command-system information, presents relevant portions of the command-system information through audio, visual, or tactile means at a ‘present incident status’ step 811. This includes providing the command-system information to the Incident Commander at a situation assessment station as well as providing this information to appropriate computerized personal incident assistants.

Those with the appropriate authority can assign or reassign incident resources (such as responder teams or responder team duties) at an ‘assign—reassign resources’ step 813.

An ‘update assignments’ step 815 communicates any changed assignments, status or other command-system information to the appropriate responders through their computerized personal incident assistant. This process repeats back to the ‘receive status update’ step 809.

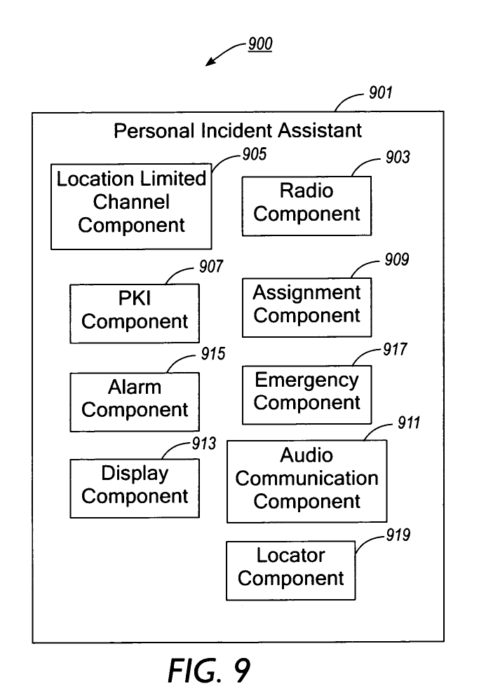

In addition, a ‘provide incident service’ function 817 provides other services to the responder and the ICS command team. These services can include secure audio communication, alarm condition notification, environmental status measurements etc. that are functions of the computerized personal incident assistant and that are subsequently detailed with respect to FIG. 9.

The current status, assignments, duties, resource allocations, and other ICS related information is generally stored at the situation assessment station (hot backup or current copies of this information can also be stored on other systems within the secure credential infrastructure so long as each member device maintains an appropriate partial or complete version of that information suitable for the role of the responder associated with the member device.

Command-system information includes spatial coordinate data, personal identification data of a responder, situation data, command hierarchy data, audio data, responsibility data, resource data, command data (tactical and/or strategic), assignment data, image data, video data, briefing data, roll call data, responder capability data, change information data, chain-of-communication data, responder team address data, location data, alarm condition data, and other digital information sent via said secure credential infrastructure.

The process for the use of a computerized personal incident assistant 800 (and devices equipped to utilize the method) can be used with an incident command system or other ad hoc command-system.

The check-in station can be a separate device, or be included within the situation assessment station. Once a responder team arrives at the check-in station and has the prospective member devices of the team members joined to the incident site PKI, information resident in the responder team's devices can be uploaded to the situation assessment station to allow the incident commander or his/her delegate to allocate the responder team and its resources. This simplifies the effort and reduces the time required for responder teams to be utilized after arriving at the incident site. The check-in station can also be configured to provide each member device with any particular compatibility software that may be needed (for example, by using ad hoc interconnectivity technologies such as developed by PARC as part of the Obje™ Software Architecture.

The situation assessment station helps automate changes to the command structure, and to help automate the delegation of function, and assignments of duties and responsibilities to each responder team. As a responder team checks in and becomes a member of the PKI, information about the team, including its location, resources, skills, and condition, will be presented to the Incident Commander or his designate. The Incident Commander can assign responsibilities to the responder team and specify the responder team's reporting structure. One skilled in the art will understand how to implement the situation assessment station features and functionality.

In addition, if a more appropriate responder arrives, the current Incident Commander can designate the more appropriate responder as the new Incident Commander and this change of command (as well as other incident information) would automatically be provided to each responder's computerized personal incident assistant. Further, the Incident Commander can assign responder teams to the appropriate ICS Sectors or can expand the command staff as the incident grows.

FIG. 9 illustrates a personal incident assistant 900 that generally resides in an enclosure 901 that provides support for the device components and appropriate external interfaces. The personal incident assistant 900 can include a selection of components such as a radio component 903 for wirelessly communicating voice (or digitized voice) and data; a location limited channel component 905 (such as an infra-red port or a near-field signaling port) used to establish the required trust prior to issuing a public key certificate; a PKI component 907 that is used to secure data communications to and from the personal incident assistant 900 (and is used when providing or receiving the public key certificate or cross-certificate); an assignment component 909 that is used to receive responder team individual and/or team assignments from the Incident Commander or delegate; an audio communication component 911 that digitizes audio information received from a microphone port (not shown) attached to the personal incident assistant 900 and that prepares the audio communication to securely sent using the PKI component 907; and that receives digital audio communications from other member devices in the PKI, converts them to analog information and presents the resulting audio signal to a headphone port (not shown) or speaker (not shown); a display component 913 that presents written or graphical instructions to the responder that are sent through the PKI; an alarm component 915 that provides the responder with information related to special alarm situations (such as fireground hazards, emergency evacuations, operational commands, etc.); an emergency component 917 that allows the responder to declare an emergency situation and that can include environmental sensors for temperature, poison, radioactivity or other threats to the responder; a locator component 919 that monitors the responder's location (such as by using inertial sensors, a global positioning system, wireless triangulation system, etc. such that a responder's location can always be known by both the responder's commander and the Incident Commander—this also automates the responder tracking system).

The PKI component 907 serves as a secure communications component and includes mechanisms to receive a key commitment through the preferred channel, to receive a public key, to verify the public key with the key commitment information and a credential receiving mechanism to receive a credential. In addition, the PKI component 907 provides security services for receiving digitized voice as well as other data that is used by the other components in the personal incident assistant 900. The information received through the secure communications component is generally presented to the responder visually through a display or as audible information through a speaker. The computers near the Incident Commander have similar capability (but generally based on a more powerful computer system). In this sense, a user can be either a responder or a member of the Incident Command Team as well as somebody in the chain-of-command.

One skilled in the art will understand how to combine these components into many possible variants of the personal incident assistant 900. Further, such a one will understand from the previous description of the involved technologies how to implement the situation assessment station and/or the check-in station.

Another use for the computerized personal incident assistant operating within a PKI is that it helps identify freelancing where one responder or responder team is operating outside of their parameters or scope of authority.

As previously described, the secure credential infrastructure can be a public key infrastructure where the credential issuing authority is a certification authority and the credential is a public key certificate.

One skilled in the art will understand that the network transmits information (such as the previously described data as well as data that defines a computer program). Generally, the information is embodied within a carrier-wave. The term “carrier-wave” includes electromagnetic signals, visible or invisible light pulses, signals on a data bus, or signals transmitted over any wire, wireless, or optical fiber technology that allows information to be transmitted over a network. Programs and data are commonly read from both tangible physical media (such as a compact, floppy, or magnetic disk) and from a network. Thus, the network, like a tangible physical media, is a computer usable data carrier.

In addition, the flowcharts provided herein are for illustrative purposes and are used to teach one embodiment of the invention. Other flowcharts that incorporate the underlying ideas (or modifications thereof) are to be considered as equivalent.

One skilled in the art will understand that embodiments of the invention vastly simplify the creation, management, and maintenance of secure credential infrastructure. Thus, a PKI can be cheaply and efficiently created and administered. Furthermore, the characteristics of some embodiments now enables the use of secure credential infrastructure in applications and environments where the expense and overhead related to traditional secure credential infrastructure were prohibitive.

From the foregoing, it will be appreciated that embodiments of the invention have (without limitation) the following advantages:
1) ability to quickly and simply create, maintain, and manage secure credential infrastructure associated with ad hoc command structures by emergency responders;
2) dramatically improved security available to emergency response organizations because of the decrease in cost and effort in creating a secure credential infrastructure now enables the emergency responders to keep their communications related to an incident secure;
3) enables simple provisioning of portable devices with incident specific information, incident specific applications;
4) enables the ability to quickly add later arriving responder teams to an existing PKI without requiring onerous trust verification processes;
5) automatically monitors the position and situation (for example temperature) of the responder and so accounts for each responder at the incident; and
6) helps identify freelancing by a responder.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A computer controlled method to establish a secure information channel that can associate a plurality of member devices with a command-system, the method comprising steps of:
establishing a secure credential infrastructure by:
exchanging key commitment information over a preferred channel between a credential issuing device and said prospective member device to pre-authenticate said prospective member device;
receiving a public key from said prospective member device;
verifying said public key with said key commitment information; and
automatically provisioning said prospective member device with a credential; whereby said prospective member device becomes one of said plurality of member devices associated with said command-system; and
communicating command-system information between some of said plurality of member devices within said secure credential infrastructure using said secure information channel.

2. The computer controlled method of claim 1, wherein said command-system is an incident command system.

3. The computer controlled method of claim 1, wherein said command-system is an ad hoc command-system.

4. The computer controlled method of claim 1, wherein said credential issuing device is one of said plurality of member devices.

5. The computer controlled method of claim 1, wherein one of said plurality of member devices serves as a check-in station.

6. The computer controlled method of claim 1, wherein one of said plurality of member devices serves as a situation assessment station.

7. The computer controlled method of claim 1, wherein one of said plurality of member devices is a computerized personal incident assistant.

8. The computer controlled method of claim 1, wherein the command-system information includes at least one datum selected from a group consisting of spatial coordinate data, personal identification data of a responder, situation data, command hierarchy data, audio data, responsibility data, resource data, command data, assignment data, image data, video data, briefing data, roll call data, responder capability data, change information data, chain-of-communication data, responder team address data, location data, alarm condition data, and other digital information sent via said secure credential infrastructure.

9. The computer controlled method of claim 1, wherein said credential issuing device includes said credential issuing authority.

10. The computer controlled method of claim 1, wherein said preferred channel is a location-limited channel.

11. The computer controlled method of claim 1, wherein said preferred channel has a demonstrative identification property and an authenticity property.

12. The computer controlled method of claim 1, wherein said secure credential infrastructure is a public key infrastructure, said credential issuing authority is a certification authority and said credential is a public key certificate.

13. The computer controlled method of claim 1, further comprising a step of revoking said credential.

14. An apparatus capable of performing communications over a secure information channel, the apparatus comprising:
at least one port configured to establish a preferred channel;
a secure communications component comprising:
a key commitment receiver mechanism configured to receive key commitment information though said at least one port;
a key receiver mechanism configured to receive a public key;
a pre-authentication mechanism configured to verify said public key with said key commitment information;
a credential receiving mechanism configured to receive a credential responsive to the pre-authentication mechanism; and
a security service mechanism configured to communicate command-system information over said secure information channel; and
a presentation component configured to present said command-system information received from the security service mechanism to a user.

15. The apparatus of claim 14, further comprising a component selected from the group consisting of a radio component, an assignment component, an emergency component, a locator component, a voice input component, and an environmental sensor component.

16. The apparatus of claim 14, wherein the presentation component is selected from a group comprising an audio communication component, a display component, and an alarm component.

17. The apparatus of claim 14, further comprising a storage device configured to store said command-system information.

18. The apparatus of claim 17, further comprising an input device configured to change said command-system information.

19. The apparatus of claim 14, further comprising an ad hoc interconnectivity module.
